(19) United States
(12) Patent Application Publication
(10) Pub. No.: US 2014/0136064 A1
(43) Pub. Date: May 15, 2014

(54) TOUCH POINT SEARCHING METHOD FOR CLUTCH

(71) Applicants: HYUNDAI MOTOR COMPANY, Seoul (KR); KIA MOTORS CORP., Seoul (KR)

(72) Inventors: Seung Sam BAEK, Jeju-si (KR); Sung Hyun Cho, Suwon-si (KR); Young Min Yoon, Seoul (KR)

(73) Assignees: Kia Motors Corp., Seoul (KR); Hyundai Motor Company, Seoul (KR)

(21) Appl. No.: 13/794,091

(22) Filed: Mar. 11, 2013

(30) Foreign Application Priority Data
Nov. 9, 2012 (KR) 10-2012-0126585

(51) Int. Cl. F16D 48/06

(52) U.S. Cl. CPC F16D 48/06
USPC 701/68

(57) ABSTRACT

A touch point searching method contributes to improving shift feel and durability of a clutch by making it possible to search and set more accurately a touch point in consideration of drag torque of an input shaft connected with the clutch such that the clutch can be more appropriately controlled.

### CROSS-REFERENCE TO RELATED APPLICATION

Noon The present application claims priority of Korean Patent Application Number 10-2012-0126585 filed Nov. 9, 2012, the entire contents of which application is incorporated herein for all purposes by this reference.

### BACKGROUND OF INVENTION

1. Field of Invention

The present invention relates to a touch point searching method for a clutch, and more particularly, to a technology that makes it possible to keep more accurately a touch point of a dry type clutch that is used for an automated manual transmission (AMT) and a double clutch transmission (DCT) mounted on a vehicle.

2. Description of Related Art

The AMT or the DCT is equipped with a clutch that can automatically connect/disconnect power by means of an actuator, and when the clutch is a dry type clutch, the touch point that is the operation start point of the clutch is changed by a temperature change or wear of the clutch, so that it is necessary to appropriately adjust the touch point in order to keep stable operability of the clutch.

FIG. 1 is a graph showing features of clutch torque for a stroke of a clutch actuator, which shows that when a stroke increasing meets a touch point, the clutch torque starts increasing, so that if the status of the clutch is stable, it is possible to transmit maximum clutch torque designed to be larger than the maximum engine torque that the engine can transmit at the maximum stroke, but if the touch point is moved by temperature change or wear of the clutch, the maximum engine torque cannot be fully transmitted even at the maximum stroke.

As described above, the touch point is a main factor that keeps an appropriate control relationship between the clutch actuator and the clutch stable and FIG. 2 illustrates a method of searching and setting the touch point of a clutch of the related art, which is used when the gear in a gearbox is at the neutral position in stopping or right after engine cranking.

That is, in the related art, a clutch actuator is operated such that a clutch that is not engaged is engaged (A), the position of the clutch actuator is determined as the touch point at the point of time when the clutch starts rotating (B), the position is adjusted as a new touch point (C), and then the clutch actuator is operated with respect to the newly set touch point.

However, there is a problem in the method of the related art in that the point of time of rotation of the clutch is changed by an influence of drag torque of an input shaft connected with the clutch, resulting in reduction of accuracy.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with the prior art.

Various aspects of the present invention provide for a touch point searching method for a clutch that makes it possible to more appropriately control a clutch and can improve shift feel and durability of the clutch, by making it possible to search and set more accurately a touch point in consideration of drag torque of an input shaft connected with the clutch.

Various aspects of the present invention provide for a touch point searching method for a clutch that includes: a basic position ensuring step that senses and stores the position where an input shaft connected with a clutch starts rotating while driving a clutch actuator such that the clutch not engaged is engaged; a drag calculation step that calculates drag torque of the input shaft by speed reduction of the input shaft that is generated while the clutch is disengaged; and a correcting step that determines a new touch point by compensating for the position ensured in the basic position ensuring step to the drag point calculated in the drag calculation step.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a graph illustrating a touch point of clutch torque for a clutch actuator stroke of the related art.

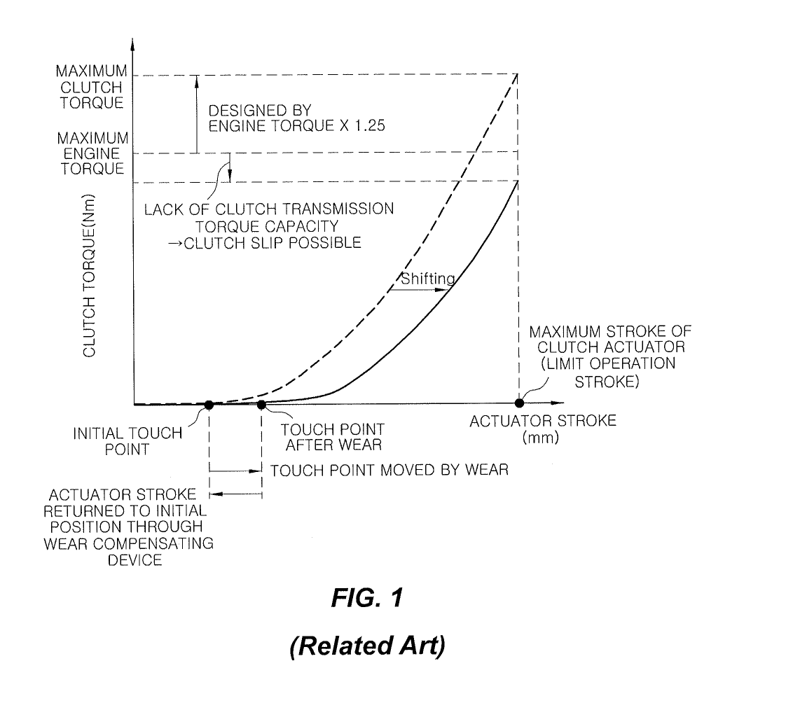

FIG. 2 is a graph illustrating a touch point searching method for a clutch of the related art.

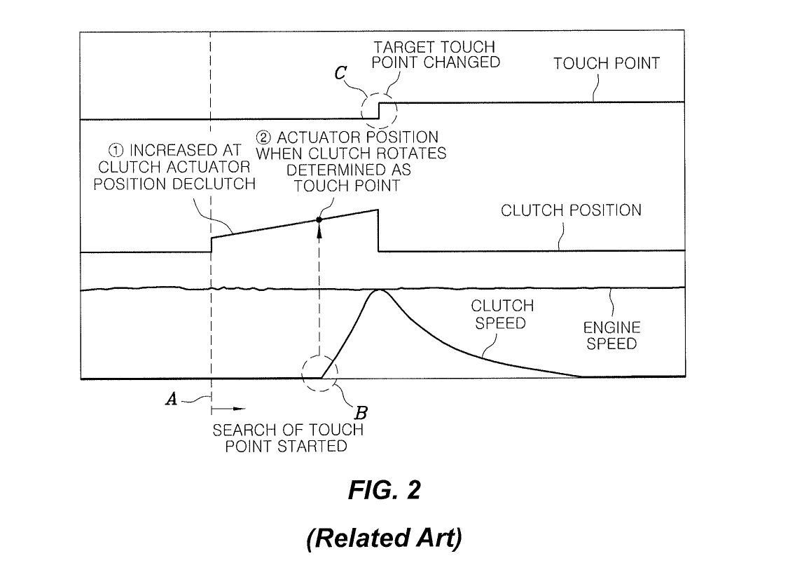

FIG. 3 is a flowchart illustrating an exemplary touch point searching method for a clutch according to the present invention.

FIG. 4 is a graph illustrating an exemplary touch point searching method according to a change in time.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

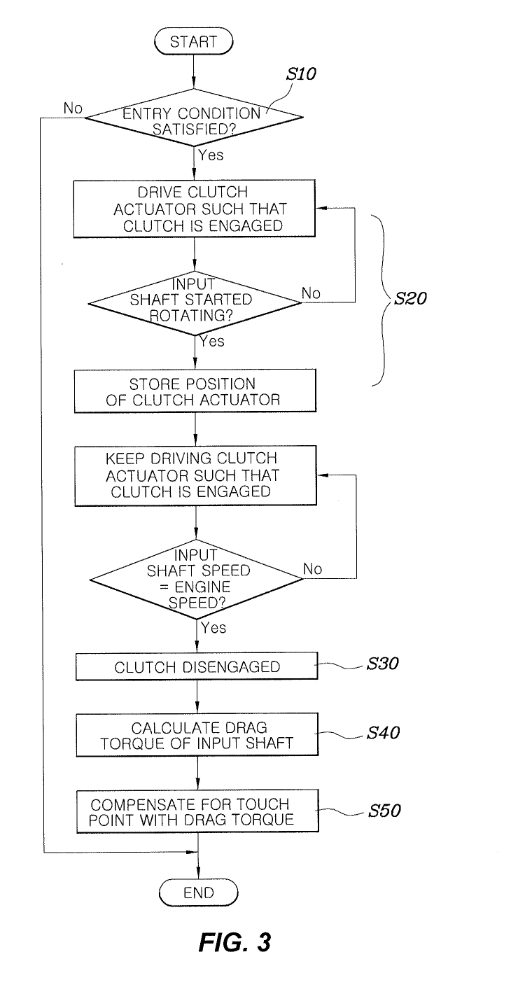

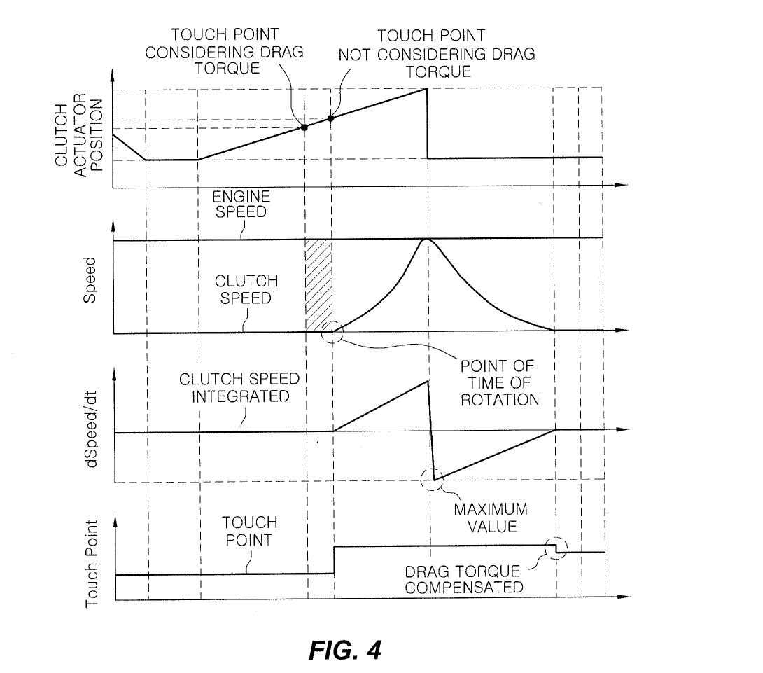

Referring to FIGS. 3 and 4, a touch point searching method for a clutch of the present invention includes: a basic position ensuring step (S20) that senses and stores the position where an input shaft connected with a clutch starts rotating while driving a clutch actuator such that the clutch not engaged is engaged; a drag calculation step (S40) that calculates drag torque of the input shaft by speed reduction of the input shaft that is generated while the clutch is disengaged; and a correcting step (S50) that determines a new touch point by compensating for the position ensured in the basic position ensuring step (S20) to the drag point calculated in the drag calculation step (S40).

That is, the basic position ensuring step (S20) determines a new touch point and makes it possible to set a more accurate touch point in consideration of the drag torque of the corresponding input shaft, by temporarily searching and storing the point where the input shaft, which stops as the clutch actuator is operated such that the clutch is engaged, starts rotating, as a reference position where a new touch point is obtained, and by applying the drag torque calculated in the drag calculation step (S40) to the reference position, for compensation.

The basic position ensuring step (S20) further includes an enter condition determining step (S10) that determines whether the condition for performing the basic position ensuring step (S20) is satisfied before the basic position ensuring step (S20), and when the engine is in an idle status, the operation amount of an acceleration pedal is zero, the brake has been operated, and the transmission is a neutral status, it is determined that the condition is satisfied in the enter condition determining step (S20).

That is, the present invention is performed only when a searching condition for an appropriate touch point is satisfied such that the touch point can be more accurately and stably searched.

The drag calculation step (S40) may be performed after a declutch step (S30) that engages the clutch after the clutch is engaged by performing the basic position ensuring step (S20) and the number of rotations of the input shaft becomes the same as the number of revolutions of the engine.

That is, while the clutch engaged in the drag calculation step (S40) is instantaneously engaged, the drag torque of the corresponding input shaft is calculated from an inclination where the rotational speed of the input shaft drops as time passes, so that it becomes possible to calculate the drag torque more accurately and stably, by performing the drag calculation step (S40), by reducing the speed of the input shaft with the clutch, which has been completely engaged to be linked with the engine, disengaged through the declutch step (S30).

The correction step (S50) determines the position moved back such that the clutch is disengaged as much as the drag torque calculated by the drag calculation step (S40) from the position ensured in the basic position ensuring step (S20), as a new touch point.

Obviously, as the amount of the drag torque is large, the position moved back further from the position ensured in the basic position ensuring step (S20), so that a touch point is more accurately searched and set in consideration of the drag torque of the input shaft, which contributes to improving durability of the clutch as well as shift feel of a vehicle.

The present invention contributes to improving shift feel and durability of a clutch by making it possible to search and set more accurately a touch point in consideration of drag torque of an input shaft connected with the clutch such that the clutch can be more appropriately controlled.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A touch point searching method for a clutch, comprising:
a basic position ensuring step (S20) that senses and stores a position where an input shaft connected with the clutch not engaged starts rotating while driving a clutch actuator such that the clutch is engaged;
a drag calculation step (S40) that calculates drag torque of the input shaft by speed reduction of the input shaft that is generated while the clutch is disengaged; and
a correcting step (S50) that determines a new touch point by compensating for the position ensured in the basic position ensuring step (S20) to a drag point calculated in the drag calculation step (S40).

2. The method of claim 1, wherein the basic position ensuring step (S20) further comprises an enter condition determining step (S10) that determines whether a condition for performing the basic position ensuring step (S20) is satisfied before the basic position ensuring step (S20), and when an engine is in an idle status, the operation amount of an acceleration pedal is zero, a brake has been operated, and a transmission is a neutral status, it is determined that the condition is satisfied in the enter condition determining step (S20).

3. The method of claim 1, wherein the drag calculation step (S40) is performed after a declutch step (S30) that engages the clutch after the clutch is engaged by performing the basic position ensuring step (S20) and the number of rotations of the input shaft becomes the same as the number of revolutions of the engine.

4. The method of claim 1, wherein the correction step (S50) determines the position moved back such that the clutch is disengaged as much as the drag torque calculated by the drag calculation step (S40) from the position ensured in the basic position ensuring step (S20), as a new touch point.
